(19) United States
(12) Patent Application Publication
(10) Pub. No.: US 2023/0271317 A1
(43) Pub. Date: Aug. 31, 2023

(54) OPERATION RANGE SETTING DEVICE, OPERATION RANGE SETTING METHOD, AND STORAGE MEDIUM

(71) Applicant: NEC Corporation, Minato-ku, Tokyo (JP)

(72) Inventor: Hisaya Wakayama, Tokyo (JP)

(73) Assignee: NEC Corporation, Minato-ku, Tokyo (JP)

(21) Appl. No.: 18/019,416

(22) PCT Filed: Aug. 14, 2020
(86) PCT No.: PCT/JP2020/030895

§ 371 Date: Feb. 2, 2023

(51) Int. Cl. B25J 9/16; G06T 7/73; G06T 7/90

(52) U.S. Cl. CPC B25J 9/1602; G06T 7/73; G06T 7/90; B25J 9/1697; G06T 2207/30204; G06T 2207/10024; G06T 2207/10028

(57) ABSTRACT

An operation range setting device 1X includes a first recognition means 15Xa, a second recognition means 15Xb, and an operation range setting means 17X. The first recognition means 15Xa is configured to recognize positions of plural reference objects. The second recognition means 15Xb is configured to recognize combinations of reference objects, the combinations each being selected to be a pair of the reference objects from the plural reference objects. The operation range setting means 17X is configured to set an operation range of a robot based on line segments, the line segments each connecting a pair of the reference object for each of the combinations.

### TECHNICAL FIELD

The present disclosure relates to a technical field of an operation range setting device, an operation range setting method, and a storage medium relating to setting of an operation range of a robot.

### BACKGROUND ART

There are proposed techniques for setting a range in which a robot operates. For example, Patent Literature 1 discloses an autonomous action robot configured to set a limited range for limiting the movement of the robot in accordance with the installation positions of predetermined markers provided in a space where the robot moves. Further, Patent Literature 2 discloses a control system for setting the operation prohibition area for SCARA (Selective Compliance Assembly Robot Arm) robot.

### CITATION LIST

### Patent Literature

Patent Literature 1: WO2019/240208
Patent Literature 2: JP 2018-144145A

### SUMMARY

### Problem to be Solved

In the setting of the operation range of a robot according to Patent Literature 1, it is necessary to set the markers to be recognized by the robot when the robot operates, and the installation positions of the markers are limited to a surface of a fixed object such as a wall. Further, Patent Literature 2 discloses such an operation range setting method applicable only for a robot whose operation axis is fixed like a SCARA robot and it cannot be applied to a robot whose operation axis intricately varies like a vertical articulated robot.

In view of the above-described issues, it is an object of the present disclosure to provide an operation range setting device, an operation range setting method, and a storage medium capable of suitably setting the operation range of a robot.

### Means for Solving the Problem

In one mode of the operation range setting device, there is provided an operation range setting device including:
a first recognition means configured to recognize positions of plural reference objects;
a second recognition means configured to recognize combinations of reference objects, the combinations each being selected to be a pair of the reference objects from the plural reference objects; and
an operation range setting means configured to set an operation range of a robot based on line segments, the line segments each connecting the pair of the reference object for each of the combinations.

In another mode of the operation range setting device, there is provided an operation range setting device including:
a recognition means configured to recognize a position of a reference object; and
an operation range setting means configured to set an operation range of a robot based on a line segment identified by the reference object.

In one mode of the operation range setting method, there is provided an operation range setting method executed by a computer, the control method including:
recognizing positions of plural reference objects;
recognizing combinations of reference objects, the combinations each being selected to be a pair of the reference objects from the plural reference objects; and
setting an operation range of a robot based on line segments, the line segments each connecting the pair of the reference object for each of the combinations.

In one mode of the storage medium, there is provided a storage medium storing a program executed by a computer, the program causing the computer to:
recognize positions of plural reference objects;
recognize combinations of reference objects, the combinations each being selected to be a pair of the reference objects from the plural reference objects; and
set an operation range of a robot based on line segments, the line segments each connecting the pair of the reference object for each of the combinations.

### Effect

An example advantage according to the present invention is to suitably set the operation range of a robot.

### BRIEF DESCRIPTION OF THE DRAWINGS

FIG. 1 illustrates a configuration of a robot management system.

FIG. 2 illustrates a hardware configuration of the operation range setting device.

FIG. 3 is a bird's-eye view of the robot and its peripheral at the time of setting the operation range of the robot.

FIG. 4 illustrates an example of a functional block indicating an outline of the process to be executed by the operation range setting device.

FIG. 5 illustrates a bird's-eye view according to a second installation example.

FIG. 6 illustrates a bird's-eye view according to a third installation example.

FIG. 7 illustrates a bird's-eye view according to a fourth installation example.

FIG. 8 illustrates an example of a flowchart to be executed by the operation range setting device in the first example embodiment.

FIG. 9 illustrates a bird's-eye view according to an installation example in a third modification.

FIG. 10A is a bird's-eye view according to an installation example in a fourth modification.

FIG. 10B illustrates an example of rule information.

FIG. 11 is a display example of the operation range setting screen image.

FIG. 12 is a bird's-eye view of the space in which the operation range of the robot is set.

FIG. 13 is a bird's-eye view in a second example embodiment according to a setting example of the operation range of the robot to be installed on a floor.

FIG. 14 is a bird's-eye view in a second example embodiment according to a setting example of the operation range of the robot to be installed on a wall.

FIG. 15 illustrates an example of a flowchart to be executed by the operation range setting device in the second example embodiment.

FIG. 16 is a schematic configuration diagram of an operation range setting device in a third example embodiment.

FIG. 17 illustrates a flowchart to be executed by the operation range setting device in the third example embodiment.

FIG. 18 is a schematic configuration diagram of the operation range setting device in a fourth example embodiment.

FIG. 19 illustrates an example of a flowchart to be executed by the operation range setting device in the fourth example embodiment.

### EXAMPLE EMBODIMENTS

Hereinafter, an example embodiment of an operation range setting device, an operation range setting method, and a storage medium will be described with reference to the drawings.

### First Example Embodiment

(1) System Configuration

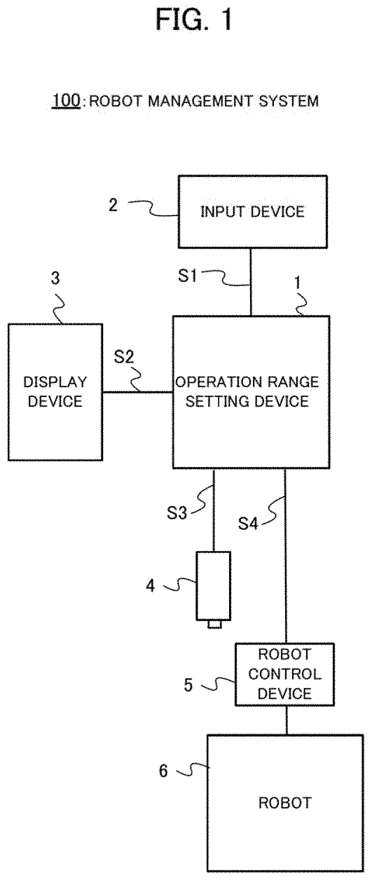

FIG. 1 shows a configuration of a robot management system 100 according to a first example embodiment. The robot management system 100 mainly includes an operation range setting device 1, an input device 2, a display device 3, a camera (imaging means) 4, a robot control device 5, and a robot 6.

The operation range setting device 1 performs, in the preprocessing stage in advance of the operation control of the robot 6 by the robot control device 5, processing for setting the operation range that is a range where the robot 6 can safely operate. The operation range setting device 1 performs data communication with the input device 2, the display device 3, the camera 4, and the robot 6 through a communication network or through wireless or wired direct communication. For example, the operation range setting device 1 receives the input information “S1” from the input device 2. Further, the operation range setting device 1 transmits the display information “S2” for displaying the information to be viewed by the user to the display device 3. The operation range setting device 1 receives a captured image “S3” generated by the camera 4 from the camera 4. Furthermore, the operation range setting device 1 supplies a setting signal “S4” relating to the setting of the operation range of the robot 6 determined by the operation range setting device 1 to the robot control device 5. The operation range setting device 1 may be a personal computer, or may be a portable terminal such as a smartphone or a tablet terminal integrated with the input device 2 and the display device 3.

The input device 2 is a device that serves as one or more interfaces for accepting user input (manual input). The input device 2 generates the input information S1 based on the user input and supplies the input information S1 to the operation range setting device 1. Examples of the input device 2 include a touch panel, a button, a keyboard, a mouse, a voice input device, and any other various user input interfaces. The display device 3 displays information based on the display information S2 supplied from the operation range setting device 1. Examples of the display device 3 include a display and a projector. The camera 4 generates the captured image S3 and supplies the generated captured image S3 to the operation range setting device 1. The camera 4 is, for example, a camera fixed at a position to overview the operable range of the robot 6.

The robot control device 5 exchanges signals with the robot 6 and controls the operation of the robot 6. In this case, the robot control device 5 receives a detection signal relating to the state of the robot 6 and a detection signal relating to the operation environment of the robot 6 from one or more sensors provided at the robot 6 or any place other than the robot 6. Further, the robot control device 5 transmits a control signal for operating the robot 6 to the robot 6. The robot control device 5 and the robot 6 communicate with each other by wired or wireless direct communication or by communication via a communication network.

Further, the robot control device 5 sets the operation range of the robot 6 based on the setting signal S4 supplied from the operation range setting device 1 and then controls the robot 6 so that the robot 6 operates within the operation range. For example, if a part of the robot 6 (e.g., either a hand or a joint of a robot arm) goes beyond the operation range set the robot control device 5, the robot control device 5 controls the robot 6 to stop in an urgent manner. The robot control device 5 may set the operation range of the robot 6 in consideration of not only the setting signal S4 indicative of the operation range but also the position of an obstacle detected by a sensor or the like provided at the robot 6 and regulation information (e.g., information on a restricted area) of the operation of the robot 6 which is previously stored in a memory or the like of the robot control device 5.

The robot 6 performs a predetermined operation based on a control signal supplied from the robot control device 5. Examples of the robot 6 include a vertically articulated robot, a horizontally articulated robot, an automated guided vehicle (AGV: Automated Guided Vehicle), and any other type of robot. The robot 6 may supply a state signal indicating the state of the robot 6 to the operation range setting device 1. The state signal may be an output signal from a sensor configured to detect a state (position, angle, and the like) of the entire robot 6 or any particular portion thereof such as a joint of the robot 6, or may be a signal indicating a progress state of the work (task) to be performed by the robot 6. The robot 6 may be equipped with not only one or more internal sensors for detecting the state (internal field) of the robot 6 but also one or more external sensors for sensing the outside (outside field) of the robot 6 such as a camera and a range measuring sensor.

The robot control device 5 or the robot 6 may perform self-position estimation and environmental mapping by performing a SLAM (Simultaneous Localization and Mapping) or the like when the robot 6 is a mobile robot.

The configuration of the robot management system 100 shown in FIG. 1 is an example, and various changes may be made to the configuration. For example, the robot control device 5 may perform operation control of a plurality of robots 6. In this case, the operation range setting device 1 generates a setting signal S4 relating to the operation range common to the plurality of robots 6. Further, the robot control device 5 may be configured integrally with the robot 6. Similarly, the robot control device 5 may be configured integrally with the operation range setting device 1. In this case, both functions of the operation range setting device 1 and the robot control device 5 may be included in the robot 6. Further, the operation range setting device 1 may be configured by a plurality of devices. In this case, the plurality of devices functioning as the operation range setting device 1 exchange information necessary for executing preassigned process with other devices by wired or wireless direct communication or by communication through a network. In this case, the operation range setting device 1 functions as an operation range setting system.

Further, during the execution of the operation range setting process by the operation range setting device 1, the robot 6 may not necessarily exist, and it may be installed in a predetermined position after the operation range setting by the operation range setting device 1.

(2) Hardware Configuration

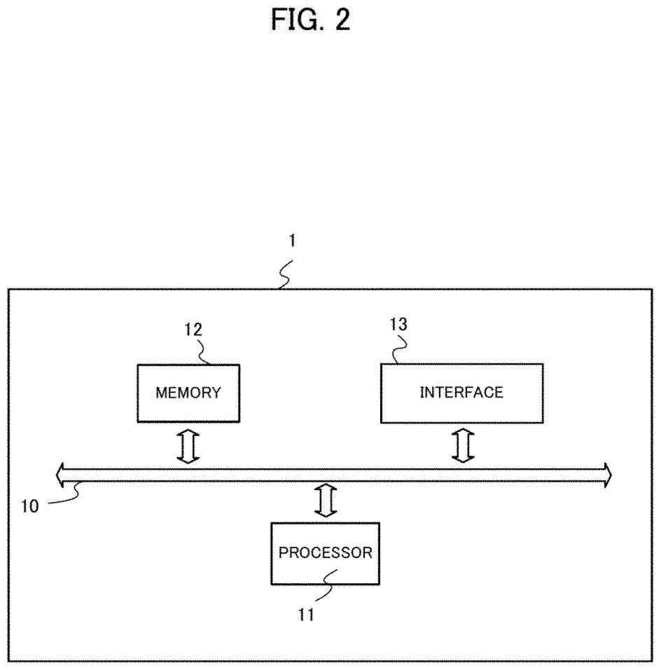

FIG. 2 shows an example of a hardware configuration of the operation range setting device 1. The operating range setting device 1 includes a processor 11, a memory 12, and an interface 13 as hardware. The processor 11, memory 12, and interface 13 are connected via a data bus 10.

The processor 11 functions as a controller (arithmetic device) configured to control the entire operation range setting device 1 by executing a program stored in the memory 12. The processor 11 is one or more processor such as a CPU (Central Processing Unit), a GPU (Graphics Processing Unit), and a TPU (Tensor Processing Unit). The processor 11 may be configured by a plurality of processors. The processor 11 is an example of a computer.

The memory 12 includes a variety of volatile and non-volatile memories, such as a RAM (Random Access Memory), a ROM (Read Only Memory), and a flash memory. Further, a program for executing a process performed by the operation range setting device 1 is stored in the memory 12. A part of the information stored in the memory 12 may be stored by one or more external storage devices capable of communicating with the operation range setting device 1, or may be stored by a storage medium removable from the operation range setting device 1.

The interface 13 is one or more interfaces for electrically connecting the operation range setting device 1 to other devices. Examples of the interfaces may include a wireless interface such as a network adapter for wirelessly transmitting and receiving data to and from other devices and a hardware interface, such as cables, for connecting the operation range setting device 1 to other devices.

The hardware configuration of the operation range setting device 1 is not limited to the configuration shown in FIG. 2. For example, the operation range setting device 1 may include at least one of an input device 2, a display device 3, or an audio output device (not shown).

(3) Outline of Operation Range Setting

An outline of the setting of the operation range of the robot 6 will be described. Schematically, when the operation range setting device 1 recognizes a paired (two) columnar objects connected by a rope based on a captured image S3 generated by the camera 4, the operation range setting device 1 determines a plane (also referred to as “safety plane”) for regulating the operation range of the robot 6 to be a plane determined based on the positions of the paired columnar objects. The safety plane, in other words, is a plane that restricts the movement of the robot 6 and functions as a plane that defines the range where the robot 6 safely operates.

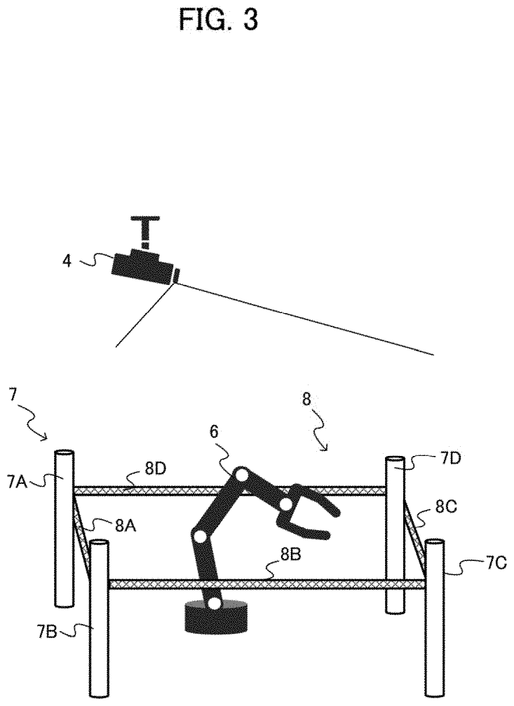

FIG. 3 is a bird's-eye view of the robot and its peripheral at the time of setting the operation range of the robot 6. As shown in FIG. 3, a plurality of columnar objects 7 (7A to 7D) and string-shaped ropes 8 (8A to 8D) connecting these columnar objects 7 are used to set the operation range of the robot 6. Here, as an example, the operation range of the robot 6 is surrounded by a combination of the columnar objects 7 and the ropes 8. Further, the robot 6 is configured as a floor-standing vertical articulated robot as an example. Further, the camera 4 is fixed at a position such that at least the robot 6 and the columnar objects 7 and the ropes 8 are included in the photographing range of the camera 4.

In this case, as a preparation for setting the operation range of the robot 6, first, the user sets a pair of columnar objects 7 at positions corresponding to both ends of each safety plane to be set and provides a rope 8 connecting each pair of the columnar objects 7. In this case, as shown in FIG. 3, a space corresponding to the operation range of the robot 6 to be set by the user is surrounded by the columnar objects 7 and the ropes 8.

Next, a schematic description will be given of the process executed by the operation range setting device 1 after the installation of the columnar objects 7 and the ropes 8. The operation range setting device 1 recognizes the presence and position of the columnar objects 7 and recognizes the presence of the ropes 8 connecting the pair of the columnar objects 7 based on the captured image S3 generated by the camera 4. Then, the operation range setting device 1 generates a safety plane for each pair of columnar objects 7 connected by a rope 8. Here, the operation range setting device 1 generates a safety plane based on the columnar object 7A and the columnar object 7B connected by the rope 8A, a safety plane based on the columnar object 7B and the columnar object 7C connected by the rope 8B, a safety plane based on the columnar object 7C and the columnar object 7D connected by the rope 8C, and a safety plane based on the columnar object 7A and the columnar object 7D connected by the rope 8C, respectively. In this instance, the operation range setting device 1 sets the respective safety planes to be perpendicular to the floor surface which is the installation surface on which the columnar objects 7A to 7D are installed. In the following, the surface (floor surface in this case) that functions as a reference for providing the safety plane is referred to as “reference surface”.

In this manner, a columnar object 7 serves as a reference object for generating a safety plane, and a rope 8 serves as a second object for recognizing a pair of reference objects. Then, the operation range setting device 1 recognizes these objects thereby to suitably generate a safety plane defining the operation range of the robot 6 desired by the user.

Here, a supplementary description will be given of the reference plane. In the present example embodiment, the operation range setting device 1 uses, as the reference plane, the coordinate plane identified by the two axes of a coordinate system (also referred to as “robot coordinate system”) with respect to the robot 6 used by the robot control device 5 as the reference in the control of the robot 6. The reference plane and the coordinate plane are parallel to an installation surface (the floor surface according to FIG. 3) where the robot 6 is installed (provided). Hereafter, the robot coordinate system is assumed to be such a three dimensional coordinate system that the robot coordinate system has three coordinate axes, the “Xr” axis, the “Yr” axis, and the “Zr” axis, and that two coordinate axes forming a reference plane are set as the Xr axis and the Yr axis and the coordinate axis perpendicular to these two coordinate axes is set as the Zr axis. Therefore, the Xr-Yr coordinate plane of the robot coordinate system is parallel to the reference plane and is a plane perpendicular to the longitudinal direction (extending direction) of the columnar object 7.

In a case where the robot 6 is a mobile type robot, the robot coordinate system may be an invariant coordinate system based on the initial position of the robot 6 at the time of the operation of the robot 6 or may be a relative coordinate system that moves in parallel according to the movement of the robot 6 (i.e., according to the position estimation result of the robot 6). Even in these cases, the Xr-Yr coordinate plane shall be parallel to the reference plane.

It is noted that the reference surface (i.e., Xr-Yr coordinate plane) is not limited to a plane parallel to the floor surface that is an installation surface on which the robot 6 is installed, and it may be a horizontal plane perpendicular to the direction of the gravitational force. Further, when the robot 6 and the columnar objects 7 are installed on a wall surface, the reference surface may be set in a plane parallel to the wall surface.

The columnar objects 7 and the ropes 8 may also be removed after the generation of the captured image S3 by the camera 4. In this case, the columnar objects 7 and the ropes 8 are not present when the robot 6 is in operation. Thus, even if the columnar objects 7 and the ropes 8 are removed so as not to become a hindrance to the worker or the like when the robot 6 is operated, the robot management system 100 can suitably set the operation range of the robot 6.

(4) Functional Block

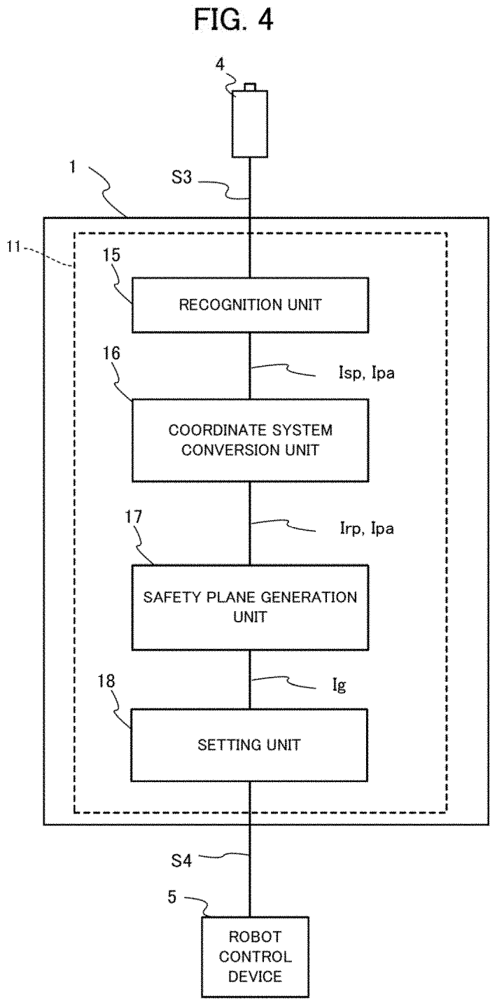

FIG. 4 is an example of a functional block showing an outline of the process to be executed by the operation range setting device 1. The processor 11 of the operation range setting device 1 functionally includes a recognition unit 15, a coordinate system conversion unit 16, a safety plane generation unit 17, and a setting unit 18. Although an example of data which the blocks exchange with each other is shown in FIG. 4, the data is not limited to the data shown in FIG. 4. The same applies to the drawings of other functional blocks described below.

The recognition unit 15 receives via the interface 13 a captured image S3 generated by the camera 4 after the installation of the columnar objects 7 and the ropes 8, and it recognizes the columnar objects 7 and the ropes 8 based on the captured image S3. In this case, for example, when the recognition unit 15 detects, based on the input information S1, a user input to acknowledge the completion of installation of the columnar objects 7 and the ropes 8, the recognition unit 15 starts generating process of the sensor coordinate system position information Isp and the reference object pair information Ipa based on the captured image S3 acquired immediately after the detection.

Here, based on the captured image S3, the recognition unit 15 generates information (also referred to as “sensor coordinate system position information Isp”) indicating the positions of the columnar objects 7 in a coordinate system (also referred to as “sensor coordinate system”) with respect to the camera 4. The sensor coordinate system is a three dimensional coordinate system based on the orientation and installation position of the camera 4 and is a coordinate system depending on the orientation and installation position of the camera 4. Furthermore, the recognition unit 15 generates information (also referred to as “reference object pair information Ipa”) indicating a pair of the columnar objects 7 connected by each rope 8. The recognition unit supplies the generated sensor coordinate system position information Isp and the reference object pair information Ipa to the coordinate system conversion unit 16. The generation method of the sensor coordinate system position information Isp will be described in the section “(5) Generation of Sensor Coordinate System Position Information”, and the specific generation method of the reference object pair information Ipa will be described in detail in the section “(6) Generation of Reference Object Pair Information”.

The coordinate system conversion unit 16 converts the sensor coordinate system position information Isp supplied from the recognition unit 15 into information (also referred to as “robot coordinate system position information Irp”) indicative of the position in the robot coordinate system which uses the X-Y coordinate plane as the reference plane. Then, the coordinate system conversion unit 16 supplies the generated robot coordinate system position information Irp and the reference object pair information Ipa to the safety plane generation unit 17. In this case, for example, information (also referred to as “coordinate system conversion information”) indicative of parameters regarding the translation and each rotation (roll, pitch, and yaw) of the coordinate system for converting the sensor coordinate system into the robot coordinate system is stored in advance in the memory 12 or the like. Then, with reference to the above-mentioned coordinate system conversion information, the coordinate system conversion unit 16 converts the sensor coordinate system position information Isp into the robot coordinate system position information Irp. The above-mentioned coordinate system conversion information is generated in advance according to a geometric method based on information on the orientation and installation position of the camera 4 and information on the orientation and installation position of the robot 6.

The safety plane generation unit 17 generates, based on the robot coordinate system position information Irp and the reference object pair information Ipa, a safety plane that is a virtual plane in the robot coordinate system, and supplies information (also referred to as “safety plane information Ig”) relating to the generated safety plane to the setting unit 18. In this instance, the safety plane generation unit 17 recognizes a line segment (also referred to as “reference line segment”) connecting the positions of a pair of columnar objects 7 on the Xr-Yr coordinate plane in the robot coordinate system identified by the robot coordinate system position information Irp, wherein the pair of columnar objects 7 is indicated by the reference object pair information Ipa. Then, the safety plane generation unit 17 generates, for each pair of columnar objects 7, a safety plane that is a plane overlapping with (passing through) the recognized reference line segment and perpendicular to the reference plane (i.e., Xr-Yr coordinate plane). For example, the generated safety plane is set to a plane which coincides with the reference line segment on the Xr-Yr coordinate plane and which infinitely extends towards the Zr direction.

The setting unit 18 generates the setting signal S4 based on the safety plane information Ig supplied from the safety plane generation unit 17, and supplies the setting signal S4 to the robot control device 5 via the interface 13. In this instance, the setting unit 18 supplies the robot control device 5 with the setting signal S4 which instructs the setting of the operation range based on the safety plane indicated by the safety plane information Ig. In this instance, after receiving the setting signal S4, the robot control device 5 determines the boundary surfaces of the operation range of the robot 6 to be the safety planes indicated by the setting signal S4 and regulates the movement of the robot 6 so that the robot 6 does not touch the safety planes.

Here, the components corresponding to the recognition unit 15, the coordinate system conversion unit 16, the safety plane generation unit 17 and the setting unit 18 described in FIG. 4, for example, can be realized by the processor 11 executing a program. Additionally, the necessary programs may be recorded on any non-volatile storage medium and installed as necessary to realize each component. It should be noted that at least a portion of these components may be implemented by any combination of hardware, firmware, and software, or the like, without being limited to being implemented by software based on a program. At least some of these components may also be implemented using user programmable integrated circuit such as, for example, a FPGA (Field-Programmable Gate Array) and a microcontroller. In this case, the integrated circuit may be used to realize a program functioning as each of the above components. At least some of the components may also be configured by an ASSP (Application Specific Standard Produce), an ASIC (Application Specific Integrated Circuit), or a quantum computer control chip. Thus, the components may be implemented by various hardware. The above explanation is also applied to other example embodiments to be described later. Furthermore, these components may be implemented by the cooperation of a plurality of computers, for example, using cloud computing technology.

(5) Generation of Sensor Coordinate System Position Information

Next, a specific example of a method of generating the sensor coordinate system position information Isp by the recognition unit 15 will be described.

In the first example, each columnar object 7 is provided with an AR marker, and the recognition unit 15 recognizes the AR marker attached to the each columnar object 7 based on the captured image S3, thereby generating the sensor coordinate system position information Isp. In this instance, the recognition unit 15 detects an image area of the AR marker recognized from the captured image S3 and analyzes the image area to thereby recognize the three dimensional position of the each columnar object 7 to which the AR marker is attached. In this instance, prior information relating to the size of the AR marker and any other features of the AR marker required for detecting the AR marker is stored in advance in the memory 12 or the like, and the recognition unit 15 performs the above-described process by referring to the prior information. In this case, the recognition unit 15 may use the recognized position of the AR marker as the position of the each columnar object 7 to which AR marker is attached. Here, the AR marker may be provided at any surface position of the each columnar object 7 that does not become a blind spot from the camera 4. It is noted that the Xr-Yr coordinate plane of the robot coordinate system is a plane perpendicular to the longitudinal (extending) direction of the columnar object 7 and that the generated safety plane is independent of the installation position of the AR marker in the longitudinal direction of the each columnar object 7.

In the second example, the camera 4 is a stereo camera, and the recognition unit 15 acquires from the camera 4 the captured image S3 that is three dimensional point cloud including the color information and the three dimensional position information for each measurement point (pixel). In this instance, based on the prior color information or/and the prior shape information of the each columnar object 7, the recognition unit 15 extracts the measurement points forming the each columnar object 7 from the three dimensional point cloud indicated by the captured image S3, and generates the sensor coordinate system position information Isp that is position information indicating the representative position of the each columnar object 7 (e.g., the position of the center of gravity indicated by the measurement points extracted for the each columnar object 7).

In the third example, if the robot management system 100 includes not only the camera 4 but also a range sensor, the robot management system 100 may generate the sensor coordinate system position information Isp based on the output signal from the range sensor and the captured image S3. In this case, for example, the recognition unit 15 identifies the three dimensional position of the each columnar object 7 by recognizing the distance corresponding to each pixel of each region of the each columnar object 7 detected in the captured image S3 based on the output signal from the range sensor.

According to any of these examples, the recognition unit 15 can suitably calculate the sensor coordinate system position information Isp regarding the columnar objects 7.

(6) Generation of Reference Object Pair Information

Next, a specific example of the method of generating the reference object pair information Ipa by the recognition unit 15 will be described.

In this instance, the recognition unit 15 extracts the image area of a rope 8 from the captured image S3 and recognizes the two columnar objects 7 existing at the both end positions of the image area of the rope 8 as a pair of the columnar objects 7. Thus, the three dimensional position information of the rope 8 is not essential for generating the reference object pair information Ipa, and the recognition unit 15 can recognize the image area of the rope 8 in the captured image S3 by recognizing a pair of the columnar object 7.

Here, a specific example of the method of extracting the image area of the rope 8 will be described. In the first example, when feature information of the rope 8 regarding the color and/or the shape is stored in advance in the memory 12 or the like, the recognition unit 15 determines the image area of the rope 8 by referring to this feature information. In this case, for example, the recognition unit 15 extracts the feature information (feature values) regarding the color, the shape, and the like from the respective image area(s) into which the captured image S3 is divided according to a region division method, and identifies the image area of the rope 8 by determining the similarity between the extracted feature information and the feature information stored in the memory 12. In the second example, a marker is attached to the rope 8, and the recognition unit detects the marker from the captured image S3 and extracts an image area of an object including the detected marker as an image area of the rope 8. In the third example, the recognition unit 15 acquires the image area of the rope 8 by inputting the captured image S3 to an inference engine configured to infer the image area of the rope 8 from an inputted image. In this case, the above-described inference engine is a learning model such as a neural network that is learned to output information on the image area of the rope 8 when the captured image S3 is inputted thereto. In addition, the recognition unit 15 may identify the image area of the rope 8 based on an arbitrary image recognition technique such as template matching.

(7) Installation Examples

Next, a description will be given of installation examples (second installation example to fourth installation example) other than the above-descripted installation example (hereinafter, referred to as “first installation example”) of the robot 6 and the columnar objects 7 shown in FIG. 3.

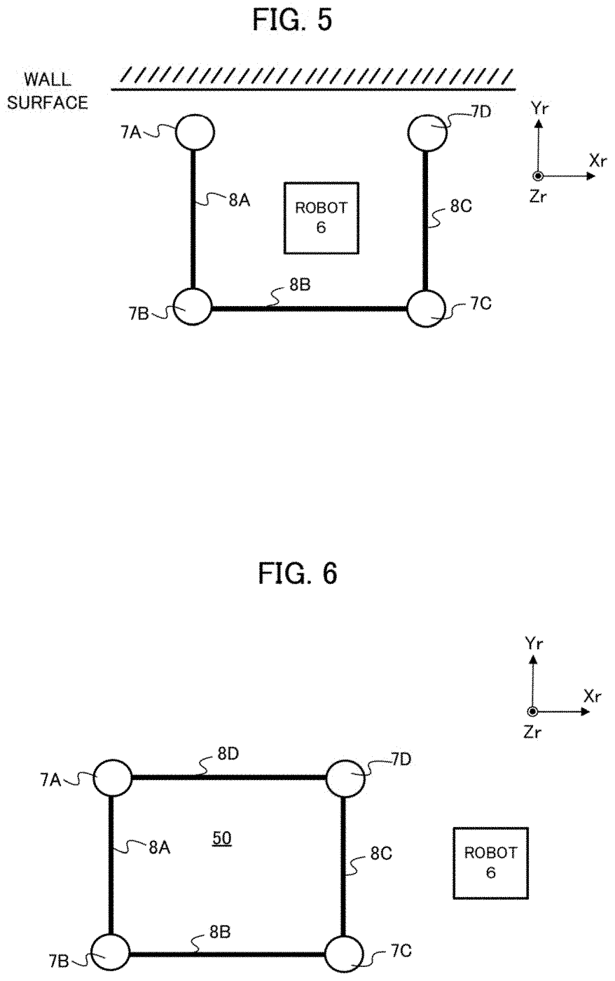

FIG. 5 is a bird's-eye view showing a second installation example of the robot 6 and the columnar objects 7. In the second installation example shown in FIG. 5, there is a floor surface along the Xr-Yr coordinate plane, and there is a wall surface which is parallel to the Xr-Zr coordinate plane and which is perpendicular to the floor surface. Then, the robots 6 are surrounded by the columnar objects 7A to 7D and the ropes 8A to 8C. Then, in this case, the operation range setting device 1 generates a safety plane corresponding to the pair of the columnar object 7A and the columnar object 7B, a safety plane corresponding to the pair of the columnar object 7B and the columnar object 7C, and a safety plane corresponding to the pair of the columnar object 7C and the columnar object 7D, respectively.

On the other hand, the operation range setting device 1 does not generate the safety plane corresponding to the pair of the columnar object 7A and the columnar object 7D, because there is no rope 8 connecting the columnar object 7A and the columnar object 7D. In this way, even in such a state that the robot 6 is not completely surrounded by the safety planes, the operation range setting device 1 can suitably set the operation range of the robot 6.

Here, a specific situation in which the rope 8 connecting the columnar object 7A and the columnar object 7D is not provided will be exemplified. For example, the situation is that the robot 6 is a floor installation type robot and that there is sufficient available clearance in the direction of the wall from the movable range of the robot 6. In this case, since it is not necessary to provide a safety plane corresponding to the pair of the columnar object 7A and the columnar object 7D, it is not necessary to provide a rope 8 connecting the columnar object 7A and the columnar object 7D. In another example, the situation is that the robot 6 is a mobile robot and that the space between the safety plane corresponding to the pair of the columnar object 7A and the columnar object 7B and the wall surface and the space between the wall surface and the safety plane corresponding to the pair of the columnar object 7C and the columnar object 7D are sufficiently narrow, respectively. In this instance, the operation of the robot 6 is substantially restrained so as not to touch the wall surface which is an obstacle, and there is no risk of moving to the outside of these safety planes. Thus, in this case, the ropes 8 connecting the columnar object 7A and the columnar object 7D may not be provided.

FIG. 6 is a bird's-eye view showing a third installation example of the robot 6 and the columnar objects 7. In the third installation example shown in FIG. 6, the robot 6 is, for example, a mobile robot, the area 50 into which the approach of the robot 6 during operation of the robot 6 is prohibited is completely surrounded. In this case, the operation range setting device 1 generates four safety planes which block the area 50 from all directions based on the recognition result regarding the columnar objects 7A to 7D and the ropes 8A to 8D. Accordingly, by installing the columnar objects 7 and the ropes 8, it is also possible to exclude the area where the approach of the robot 6 during the operation of the robot 6 is desired to be prohibited from the operation range of the robot 6.

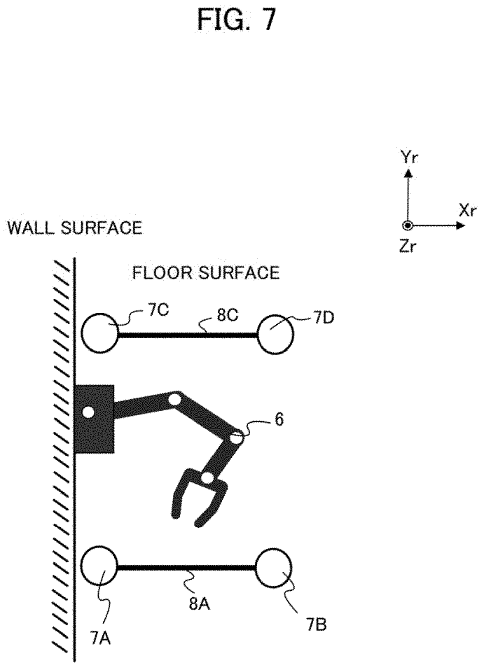

FIG. 7 is a bird's-eye view showing a fourth installation example of the robot 6 and the columnar objects 7. In the fourth installation example shown in FIG. 7, while the robot 6 is installed on the wall surface, the columnar objects 7A to 7D are installed so as to be perpendicular to the floor surface. Then, there are a rope 8A connecting the columnar object 7A and the columnar object 7B and a rope 8C connecting the columnar object 7C and the columnar object 7D. In addition, as an example, the Xr-Yr coordinate plane of the robot coordinate system is set to be parallel to the floor surface, as in the first installation example to the third installation example.

In this instance, the operation range setting device 1 generates a safety plane which is perpendicular to the floor surface and which overlaps with the reference line segment identified by the pair of the columnar object 7A and the columnar object 7B, and, a safety plane which is perpendicular to the floor surface and which overlaps with the reference line segment identified by the pair of the columnar object 7C and the columnar object 7D, respectively. Thus, the operation range setting device 1 can be suitably set the operation range of the robot 6 installed on the wall surface.

In such a case where the columnar objects 7 can be installed perpendicularly to the wall surface, the columnar objects 7 may be installed on the wall surface. In this case, the robot 6 uses a wall surface perpendicular to the columnar objects 7 as a reference surface, and generates the safety planes which are perpendicular to the reference surface and which overlap with the reference line segments identified by pairs of the columnar objects 7, respectively. In this case, for example, the operation range setting device 1 can generate the safety planes so as to limit the operation range of the robot 6 in the height (vertical) direction.

(8) Processing Flow

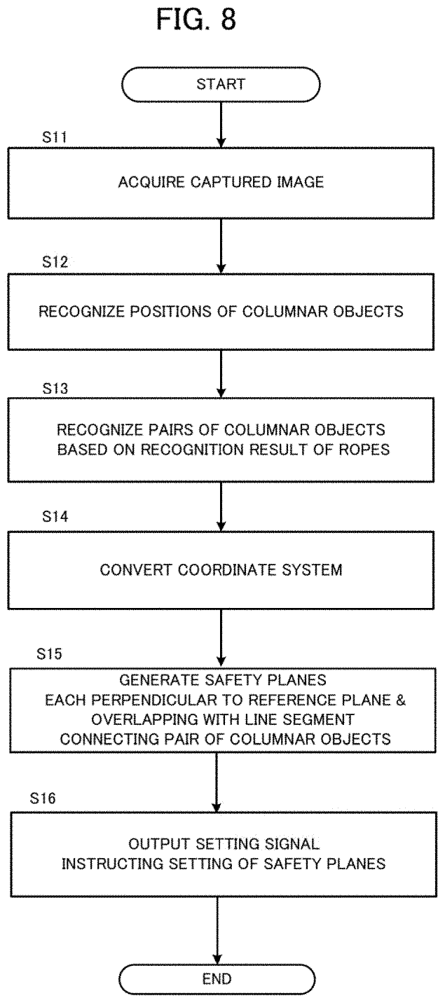

FIG. 8 is an example of a flowchart in which the operation range setting device 1 executes in the first example embodiment.

First, the recognition unit 15 of the operation range setting device 1 acquires the captured image S3 from the camera 4 through the interface 13 after the installation of the columnar objects 7 and the ropes 8 (step S11). Then, the recognition unit 15 recognizes the positions of the columnar objects 7 based on the captured image S3 acquired at step S11 (step S12). Thereby, the recognition unit 15 generates the sensor coordinate system position information Isp regarding the columnar objects 7.

Then, the recognition unit 15 recognizes each rope 8 based on the captured image S3 acquired at step S11, and recognizes each pair of the columnar objects 7 based on the recognition result of the each rope 8 (step S13). In this case, the recognition unit 15 regards the two columnar objects 7 located at both ends of a rope 8 as the pair and executes this process by the number of the ropes 8. Accordingly, the recognition unit 15 generates reference object pair information Ipa.

Next, the coordinate system conversion unit 16 performs the conversion of the coordinate system regarding the sensor coordinate system position information Isp (step S14). In this instance, for example, the coordinate system conversion unit 16 converts the sensor coordinate system position information Isp into the robot coordinate system position information Irp based on the coordinate system conversion information stored in advance in the memory 12 or the like.

Next, the safety plane generation unit 17 generates safety planes that are planes which are perpendicular to the reference plane and which overlap with the reference line segments, respectively, wherein the reference line segments connect pairs of columnar objects 7 recognized at step S13, respectively (step S15). In this instance, the safety plane generation unit 17 recognizes, for each pair of the columnar objects 7 indicated by the reference object objective information Ipa, a reference line segment connecting the positions of the columnar objects 7 indicated by the robot coordinate system position information Irp, and generates the safety planes for the respective reference line segments.

Then, the setting unit 18 outputs a setting signal S4 instructing the setting of the safety planes generated by the safety plane generation unit 17 (step S16). In this instance, the setting unit 18 supplies the setting signal S4 to the robot control device 5 through the interface 13. Thereafter, the robot control device 5 controls the robot 6 so that the robot 6 does not touch the safety planes specified by the setting signal S4. It is noted that the columnar objects 7 and the ropes 8 may be removed by the time of controlling the robot 6.

(9) Modifications

A description will be given of preferred modifications to the example embodiment described above. The following modifications may be applied to the above-described example embodiment in combination.

(First Modification)

The camera 4 may be a camera provided in the robot 6.

In this case, for example, the robot 6 turns 360 degrees while keeping the elevation angle of the camera 4 such an angle that the columnar object 7 is included in the view of the camera 4, thereby supplying the operation range setting device 1 with a plurality of captured images S3 indicating a 360 degree view from the robot 6. The operation range setting device 1 generates the sensor coordinate system position information Isp and the reference object pair information Ipa on the basis of the plurality of captured images S3. In this instance, the operation range setting device 1 generates three dimensional measurement information (i.e., environment map) of the environment at or around the robot 6 by synthesizing a plurality of captured images S3, and based on the three dimensional measurement information, identifies information regarding the columnar objects 7 and the ropes 8 (i.e., generates the sensor coordinate system position information Isp and the reference object pair information Ipa). For example, such three dimensional measurement information may be generated based on any SLAM technique.

Thus, even when the camera 4 is provided in the robot 6, the robot 6 moves so that the camera 4 captures the surrounding environment. Therefore, the operation range setting device 1 can acquire the captured images S3 required for recognizing the columnar objects 7 and the ropes 8.

The robot management system 100 may be equipped with an external sensor other than a camera capable of detecting the columnar objects 7 and the ropes 8, instead of the camera 4. In this instance, the operation range setting device 1 generates the sensor coordinate system position information Isp and the reference object pair information Ipa based on the information generated by the external sensor. In this case, for example, model information indicating a model that simulates the columnar objects 7 and the ropes 8 is stored in the memory 12, and the operation range setting device 1 extracts, from the three dimensional point cloud information generated by a range sensor, point cloud information regarding the columnar objects 7 and the ropes 8, for example, by performing matching process between three dimensional point cloud information and the model information. Thus, even when using an external sensor other than the camera, the operation range setting device 1 can suitably execute the recognition process of the columnar objects 7 and the ropes 8.

(Second Modification)

The columnar object 7 does not need to be a column in the strict sense, and it may be an object extending substantially perpendicular to the installation surface. For example, the columnar object 7 may be a tapered object or a cone. Even in this case, the operation range setting device 1 generates, based on the captured image S3, the sensor coordinate system position information Isp indicating the positions of the columnar objects 7 on the reference plane to thereby suitably specify the reference line segments and generate the safety planes.

Further, the rope 8 does not need to be a string-like object, and may be a planar object such as a tape. Even in this case, the operation range setting device 1 can suitably recognize the pair of the columnar objects 7 by detecting the above-mentioned objects in the captured image S3.

(Third Modification)

Instead of recognizing a pair of columnar objects 7 tied by a rope 8, the recognition unit may recognize, as a pair of the columnar objects 7, two columnar objects 7 with a predetermined positional relation with a predetermined object.

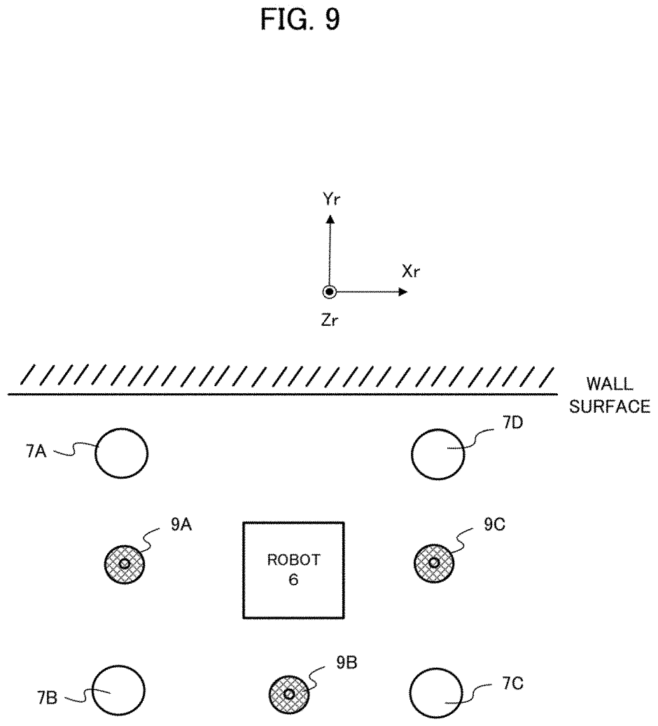

FIG. 9 is a bird's-eye view showing an installation example of the robot 6 and the columnar objects 7 in the third modification. In this instance, each cone 9 (9A to 9C) is provided between each pair of the columnar objects 7. In this instance, the recognition unit 15 recognizes the three dimensional positions of the cones 9A to 9C in the sensor coordinate system in the same manner to recognize the columnar objects 7A to 7D by applying any image recognition technique to the captured image S3. Then, based on the position information of the columnar objects 7A to 7D and the position information of the cones 9A to 9C, the recognition unit 15 recognizes that the cone 9A is present between the columnar object 7A and the columnar object 7B, the cone 9B is present between the columnar object 7B and the columnar object 7C, and the cone 9C is present between the columnar object 7C and the columnar object 7D, respectively. In this instance, the recognition unit 15 recognizes the pair of the columnar object 7A and the columnar object 7B, the pair of the columnar object 7B and the columnar object 7C, the pair of the columnar object 7C and the columnar object 7D, respectively, and generates reference object pair information Ipa indicating these relations.

Thus, in the example shown in FIG. 9, second objects (cones 9 in FIG. 9) other than the columnar objects 7 to be reference objects are provided with a predetermined positional relation (such relations that each second object is placed between each pair of the columnar objects 7) with the corresponding pairs of columnar objects 7, respectively. Even in this case, the operation range setting device 1 can suitably recognize a pair of columnar objects 7 that generates a safety plane.

(Fourth Modification)

Only columnar objects 7 may be provided without the ropes 8 being provided.

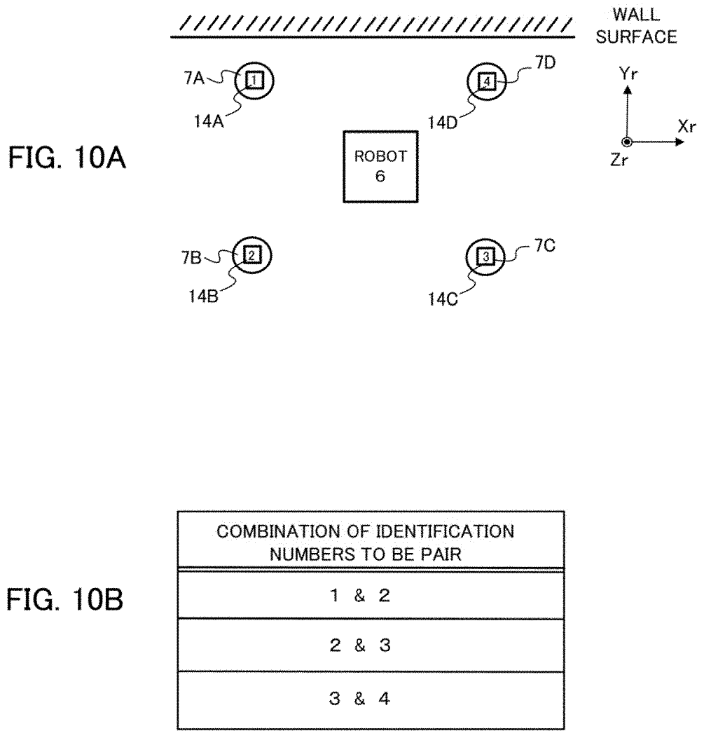

FIG. 10A is a bird's-eye view showing an installation example of the robot 6 and the columnar objects 7 in the fourth modification. In this instance, the columnar objects 7A to 7D are provided with markers 14A to 14D, respectively. Here, each of the markers 14A to 14D functions as an AR marker, and is a marker with which the identification number can be identified. Here, as an example, it is assumed that the serial identification numbers “1” to “4” are assigned to the markers 14A to 14D, respectively.

Further, information (also referred to as “rule information”) indicating the rule of a combination of identification numbers to be considered as a pair is stored in the memory 12 or the like of the operation range setting device 1. FIG. 10B illustrates an example of the rule information. The rule information may be updated based on the input information S1 supplied from the input device 2. Further, the memory 12 or the like stores information required for recognizing the markers 14A to 14D as AR markers.

Then, the recognition unit 15 of the operation range setting device 1 detects the markers 14A to 14D attached to the columnar objects 7A to 7D on the basis of the captured image S3 and recognizes each identification number of the markers 14A to 14D. Further, the recognition unit recognizes the three dimensional positions of the columnar object 7A to the columnar object 7D corresponding to the respective markers 14A to 14D by analyzing the image areas of the markers 14A to 14D in the captured image S3, and generates the sensor coordinate system position information Isp. Further, the recognition unit 15 recognizes each pair of the columnar objects 7 based on the identification numbers of the markers 14A to 14D and the rule information shown in FIG. 10B, and generates the reference object pair information Ipa. In this example, the recognition unit 15 generates the reference object pair information Ipa which designates following pairs: the columnar object 7A and a columnar object 7B; the columnar object 7B and the columnar object 7C; and the columnar object 7C and the columnar object 7D, respectively.

Thus, even when any rope 8 is not provided, the operation range setting device 1 can recognize a pair of columnar objects 7 that generates a safety plane. Instead of using the identifiable markers 14A to 14D, the columnar objects 7A to 7D may be configured to be identifiable by themselves. In this case, for example, the columnar objects 7A to 7D may have different colors, patterns, shapes, or sizes from one another.

(Fifth Modification)

The recognition unit 15 may recognize the paired columnar objects 7 based on the input information S1 supplied from the input device 2.

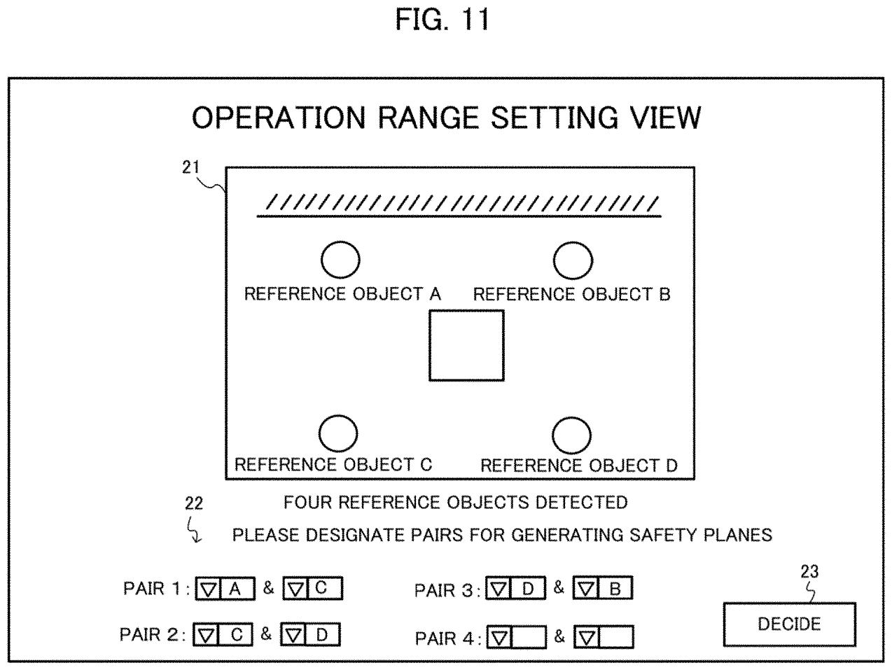

FIG. 11 is a display example of an operation range setting screen image to be displayed on the display device 3 by the recognition unit 15 based on the display information S2 according to the fifth modification. The recognition unit 15 mainly includes a reference object display area 21, a pair designation area 22, and a determination button 23 on the operation range setting screen image.

The recognition unit 15 displays, on the reference object display area 21, the captured image S3. Here, the recognition unit 15 assigns four pieces of identification information “reference object A” to “reference object D” to the four columnar objects 7 detected from the captured image S3 through an image recognition process, respectively, and displays the four pieces of the identification information on the captured image S3 in association with the image areas of the four columnar objects 7, respectively. Instead of displaying the captured image S3 on the reference object display area 21, the recognition unit 15 may display computer graphics modeling the captured area of the captured image S3 based on the captured image S3.

Further, the recognition unit 15 displays, on the pair designation area 22, a user interface for designating pairs of the columnar objects 7. Here, the recognition unit 15 displays two pull-down menus for each pair to be designated. Each pull-down menu is capable of accepting the designation of any combination of the columnar objects 7 (reference object A to reference object D) as a pair.

Then, when the recognition unit 15 detects that the determination button 23 is selected, the recognition unit 15 generates the reference object pair information Ipa based on the input information S1 indicating the pairs of columnar objects 7 designated in the pair designation area 22. Thus, based on the user input, the recognition unit 15 can suitably recognize the pairs of the columnar objects 7 for generating safety planes.

(Sixth Modification)

The operation range setting device 1 may generate a safety plane based on a reference line segment obtained by translating a reference line segment identified based on the robot coordinate system position information Irp by a predetermined distance. Hereafter, the reference line segment before the translation is referred to as “first reference line segment”, and the reference line segment after the translation is referred to as “second reference line segment” or “second line segment”.

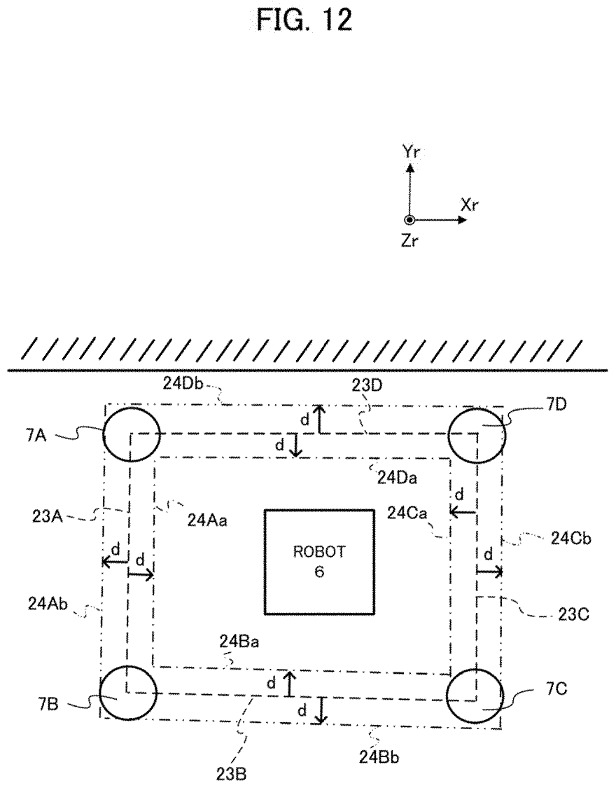

FIG. 12 is a bird's-eye view of the space for setting the operation range of the robot 6. In FIG. 12, for convenience of explanation, the display of the ropes 8 is omitted, and the first reference line segments 23A to 23D and the second reference line segments 24Aa to 24Da, 24Ab to 24db are clearly shown, respectively. Here, in the same way as in the first installation example shown in FIG. 3, it is assumed that the columnar object 7A and columnar object 7B, columnar object 7B and columnar object 7C, the columnar object 7C and columnar object 7D, the columnar object 7A and columnar object 7D are recognized as pairs, respectively.

As shown in FIG. 12, the safety plane generation unit 17 of the operation range setting device 1 recognizes the first reference line segments 23A to 23D based on the robot coordinate system position information Irp regarding each columnar object 7A to columnar object 7D. Thereafter, the safety plane generation unit 17 sets the second reference line segments 24Aa to 24Da and the second reference line segments 24Ab to 24db which are the first reference line segments 23A to 23D translated by a distance “d” in the both direction perpendicular to the first reference line segments 23A to 23D on the reference plane (here the floor surface), respectively. In other words, the safety plane generation unit 17 sets the second reference line segments 24Aa to 24Da that are the first reference line segments 23A to 23D translated by the distance d so as to shrink, with similarity conversion, the rectangular area formed by the first reference line segments 23A to 23D, while the safety plane generation unit 17 sets the second reference line segments 24Ab to 24Db translated by the distance d so as to expand, with similarity conversion, the rectangular area formed by the first reference line segments 23A to 23D. In this instance, for example, the safety plane generation unit 17 translates the first reference line segments 23A to 23D in both directions of perpendiculars from the the installation position (e.g., representative position such as the center of gravity position) of the robot 6 to the first reference line segments 23A to 23D, respectively. When the first reference line segments form a closed region, the safety plane generation unit 17 may change the lengths of the second reference line segments from the lengths of the first reference line segments before the translation into the lengths so that the second reference line segments also form a closed region.

In this instance, for example, information indicative of the distance d is stored in the memory 12 or the like, and by referring to the memory 12 or the like, the safety plane generation unit 17 sets the second reference line segments 24Aa to 24Da and the second reference line segments 24Ab to 24Db from the first reference line segments 23A to 23D.

Then, the safety plane generation unit 17 generates the safety planes which overlap with the second reference line segments 24Aa to 24Da and the second reference line segments 24Ab to 24Db, respectively, and which are perpendicular to the reference plane (here the floor surface). In this situation, the safety planes based on the second reference line segments 24Aa to 24Da are set at positions shifted toward the robot 6 from the positions determined by the positions of the columnar object 7A to the columnar object 7D, respectively. Therefore, in this case, the operation range setting device 1 can suitably set the operation range of the robot 6 so as to operate the robot 6 more safely at the time of operation of the robot 6. Further, provided that the installation position of the robot 6 shown in FIG. 12 exists outside the surrounded area by the columnar objects 7A to 7D, i.e., when it is assumed that the approach prohibition area of the robot 6 is surrounded by the columnar objects 7A to 7D, the safety plane generation unit 17 generates safety planes such that the approach prohibition area is expanded on the basis of the second reference line segments 24Ab to 24Db. Therefore, even in this case, the operation range setting device 1 can suitably set the operation range of the robot 6 so as to operate the robot 6 more safely at the time of operation of the robot 6.

(Seventh Modification)

The recognition unit 15 may generate the position information regarding the columnar objects 7 in the robot coordinate system instead of generating the sensor coordinate system position information Isp. In this case, the operation range setting device 1 does not need to include a coordinate system conversion unit 16.

### Second Example Embodiment

The second example embodiment is different from the first example embodiment in that the safety planes are generated based on the positions of tapes on the floor or wall instead of the safety plane being generated based on the positions of the paired columnar objects 7. In the second example embodiment, the same components as those of the first example embodiment are appropriately denoted by the same reference numerals, and a description thereof will be omitted.

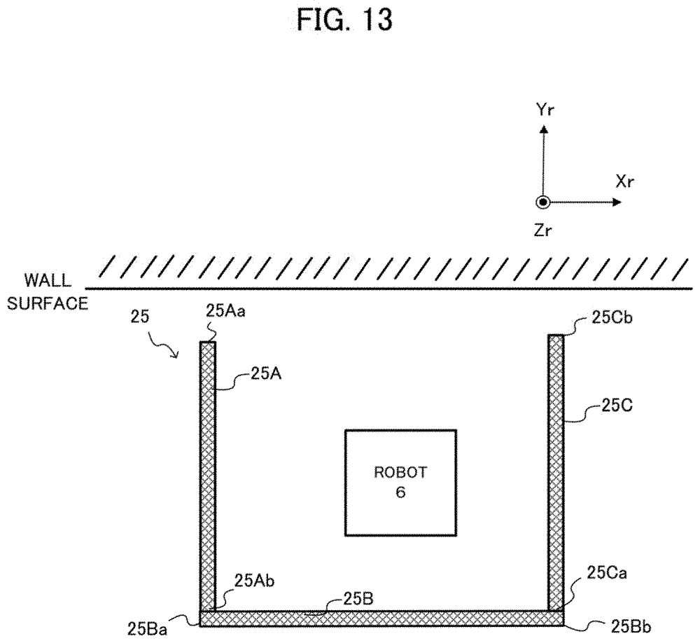

FIG. 13 is a bird's-eye view showing a setting example of the operation range of the robot 6 to be installed on the floor in the second example embodiment. In FIG. 13, tapes 25 (25A to 25C) for setting the operating range of the robot 6 are applied to the floor. Here, as an example, the tapes 25 are applied to the floor so that the same safety planes as in the second installation example shown in FIG. 5 described in the first example embodiment are generated.

In this instance, the recognition unit 15 of the operation range setting device 1 detects the tapes 25A to 25C based on the captured image S3 and generates the sensor coordinate system position information Isp indicating the positions of both ends of the tape 25A to the tape 25C. Specifically, the recognition unit 15 generates the sensor coordinate system position information Isp indicating each position of:
both ends 25Aa and 25Ab of the tape 25A;
both ends 25Ba and 25Bb of the tape 25B; and
both ends 25Ca and 25Cb of the tape 25C.

Furthermore, the recognition unit 15 generates reference object pair information Ipa that specifies the both ends as a pair for each of the tape 25A to the tape 25C.

Then, the coordinate system conversion unit 16 generates robot coordinate system position information Irp obtained by applying the coordinate system conversion to the sensor coordinate system position information Isp. Based on the robot coordinate system position information Irp and the reference object pair information Ipa, the safety plane generation unit 17 generates reference line segments connecting the both end positions of each of the tapes 25A to 25C. Then, based on each reference line segment, the safety plane generation unit 17 generates a safety plane perpendicular to the reference plane. In this case, the safety plane generation unit 17 respectively generates:
a safety plane based on the reference line segment connecting the both ends 25Aa and 25Ab of the tape 25A;
a safety plane based on a reference line segment connecting the both ends 25Ba and 25Bb of the tape 25B; and
a safety plane based on a reference line segment connecting the both ends 25Ca and 25Cb of the tape 25C.

Thus, the operation range setting device 1 according to the second example embodiment can suitably generate safety planes according to the positions of the tapes 25 set by the user by recognizing the tapes 25 applied to the floor surface. In this case, the user can cause the operation range setting device 1 to set the desired operation range by taping the floor with the tapes 25.

Here, a specific example embodiment of a method for generating the sensor coordinate system position information Isp will be described. In the first example, the recognition unit 15 generates the sensor coordinate system position information Isp based on the pixel positions (i.e., the direction of each tape 25 from the camera 4) of each tape 25 identified based on the captured image S3 and the position information of the floor surface. In this case, for example, the memory 12 or the like which the recognition unit 15 can refer to stores the position information, in the sensor coordinate system, of the floor surface (i.e., the reference surface) to which the tapes 25 are attached. In the second example, both ends of the tapes 25A to 25C are provided with AR markers or the like for recognizing the three dimensional positions, in the same way as the columnar objects 7 according to the first example embodiment, and the recognition unit 15 recognizes the AR markers to generate the sensor coordinate system position information Isp. In the third example, the camera 4 is a stereo camera, and the recognition unit 15 generates the sensor coordinate system position information Isp by specifying the measurement information corresponding to the tapes 25 from the three dimensional measurement information generated by the camera 4.

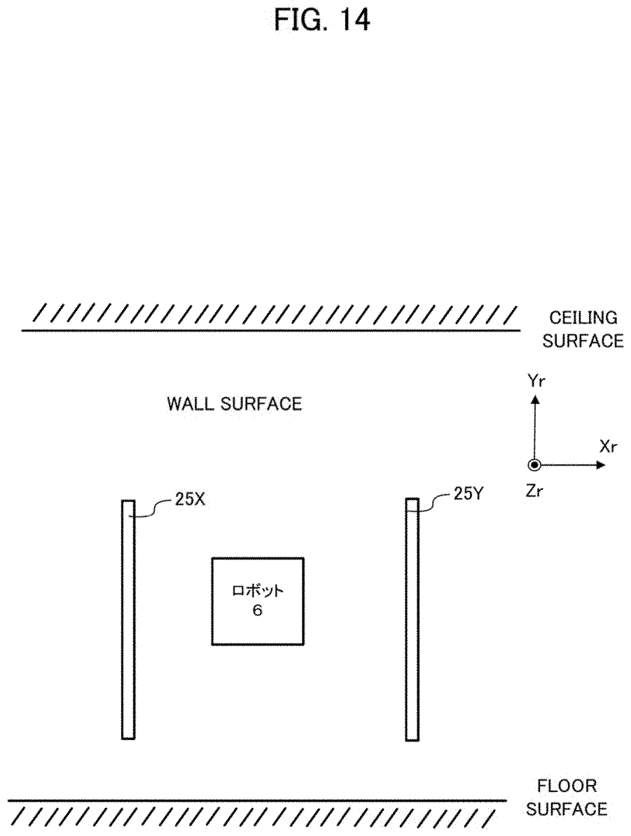

FIG. 14 is a bird's-eye view showing a setting example of the operation range of the robot 6 installed on the wall in the second example embodiment. In FIG. 14, the robot 6 is installed on the wall, and tapes 25 (25X, 25Y) for setting the operation area of the robot 6 are applied to the wall surface. Here, the plane parallel to the wall surface is set as the reference surface, and Xr axis and Yr axis are set so as to be parallel to the wall surface.

In this instance, the recognition unit 15 of the operation range setting device 1 detects the tape 25X and the tape 25Y on the basis of the captured image S3 and generates the sensor coordinate system position information Isp indicating the positions of both ends of the tape 25X and the tape 25Y. The recognition unit 15 generates reference object pair information Ipa that specifies both end positions of the tape 25X and both end positions of the tape 25Y as pairs of reference objects, respectively. Then, the coordinate system conversion unit 16 generates robot coordinate system position information Irp obtained by applying the coordinate system conversion to the sensor coordinate system position information Isp. The safety plane generation unit 17 generates a reference line segment connecting both end positions of the tape 25X and a reference line segment connecting both end positions of the tape 25Y based on the robot coordinate system position information Irp and the reference object pair information Ipa, and generates safety planes perpendicular to the reference plane based on the respective reference line segments.

Thus, the operation range setting device 1 according to the second example embodiment can also generate a safety plane at a position corresponding to the position of a tape 25 by recognizing the tape 25 applied to the wall surface. Therefore, even when the robot 6 is installed on the wall, the user can suitably cause the operation range setting device 1 to set the desired operating range.

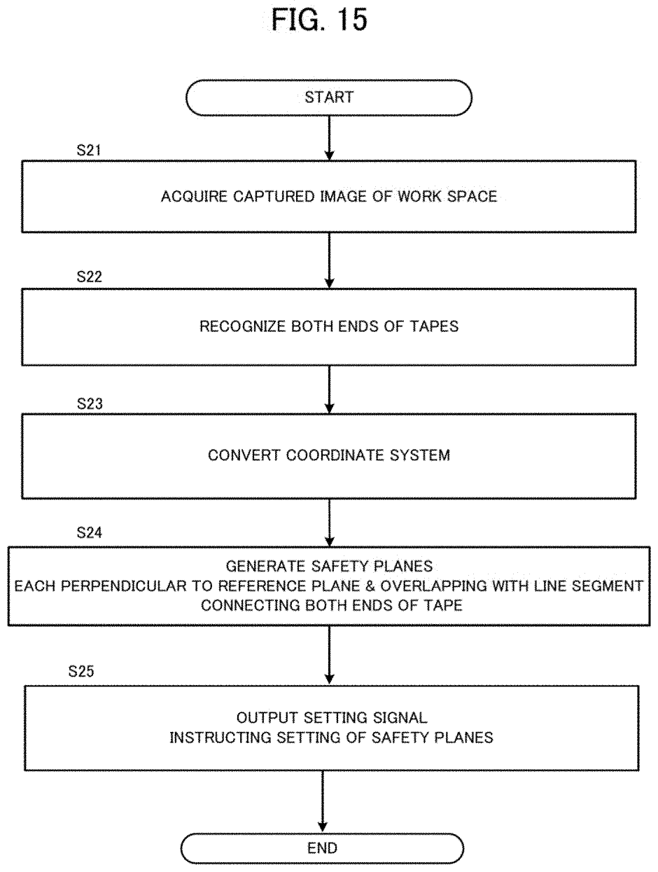

FIG. 15 is an example of a flowchart in which the operation range setting device 1 executes in the second example embodiment.

First, the recognition unit 15 of the operation range setting device 1 acquires the captured image S3 from the camera 4 through the interface 13 after installation of the tapes 25 (step S21). Then, the recognition unit 15 recognizes both end positions of each tape 25 based on the captured image S3 acquired at step S21 (step S22). Thereby, the recognition unit 15 generates the sensor coordinate system position information Isp regarding both end positions of each tape 25.

Then, the coordinate system conversion unit 16 applies the coordinate system conversion to the sensor coordinate system position information Isp (step S23). In this instance, for example, based on the coordinate system conversion information stored in advance in the memory 12 or the like, the coordinate system conversion unit 16 converts the sensor coordinate system position information Isp in the sensor coordinate system into the robot coordinate system position information Irp in the robot coordinate system.

Next, the safety plane generation unit 17 generates safety planes each of which is a plane that overlaps with the reference line segment connecting the both end positions of each tape 25 and that is perpendicular to the reference plane (step S24). In this instance, for each tape 25, the safety plane generation unit 17 recognizes a reference line segment connecting the both end positions of the each tape 25 in the robot coordinate system indicated by the robot coordinate system position information Irp, and generates the safety planes based on the respective reference line segments. Then, the setting unit 18 outputs a setting signal S4 instructing the setting of the safety planes generated by the safety plane generation unit 17 (step S25).

Instead of setting the reference line segment by recognizing the both end positions of each tape 25, the operation range setting device 1 may calculate an approximate straight line (line segment) approximating each tape 25 and set the approximate line segment as the reference line segment. In this case, for example, based on the least squares method or the like using the position of each tap in the sensor coordinate system in the captured image S3, the operation range setting device 1 calculates the approximate straight line for each tape 25 forming a line segment. Even in this mode, the operation range setting device 1 can suitably generate a safety plane for each tape 25 forming a line segment.

### Third Example Embodiment

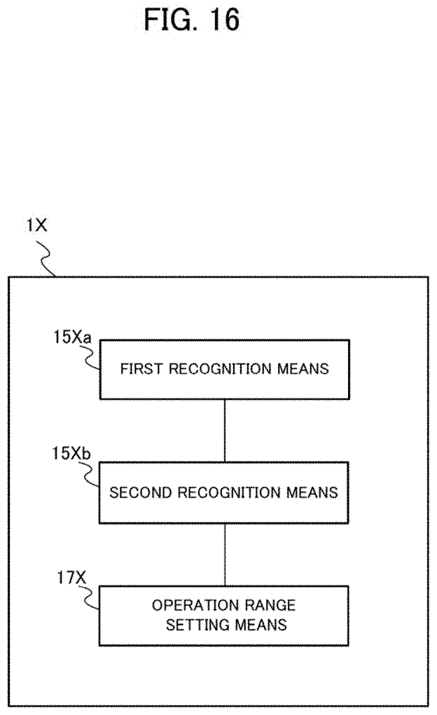

FIG. 16 is a schematic configuration diagram of an operation range setting device 1X according to the third example embodiment. As shown in FIG. 16, the operation range setting device 1X includes a first recognition means 15Xa, a second recognition means 15Xb, and an operation range setting means 17X. The operation range setting device 1X may be configured by a plurality of devices.

The first recognition means 15Xa is configured to recognize positions of plural reference objects. The second recognition means 15Xb is configured to recognize combinations of reference objects, the combinations each being selected to be a pair of the reference objects from the plural reference objects. The first recognition means 15Xa and the second recognition means 15Xb may be, for example, the recognition unit 15 in the first example embodiment.

The operation range setting means 17X is configured to set an operation range of a robot based on line segments, the line segments each connecting a pair of the reference object for each of the combinations. For example, the operation range setting means 17X may be a combination of the safety plane generation unit 17 and the setting unit 18 in the first example embodiment.

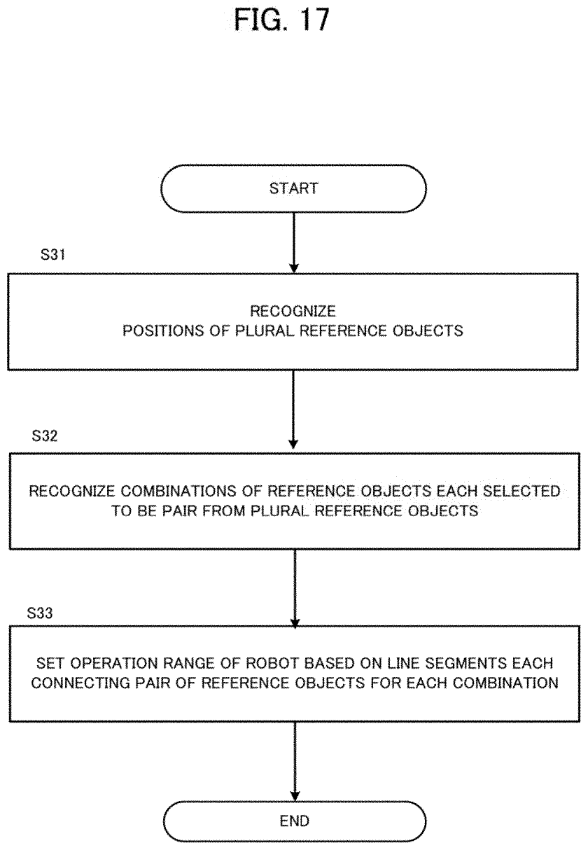

FIG. 17 illustrates an example of a flowchart in which the operation range setting device 1X executes in the third example embodiment. The first recognition means 15Xa recognizes positions of plural reference objects (step S31). The second recognition means 15Xb recognizes combinations of reference objects, the combinations each being selected to be a pair of the reference objects from the plural reference objects (step S32). The operation range setting means 17X sets an operation range of a robot based on line segments, the line segments each connecting the pair of the reference object for each of the combinations (step S33).

According to the third example embodiment, the operation range setting device 1X can suitably set the operation range of the robot based on plural reference objects installed in accordance with the desired operation range.

### Fourth Example Embodiment

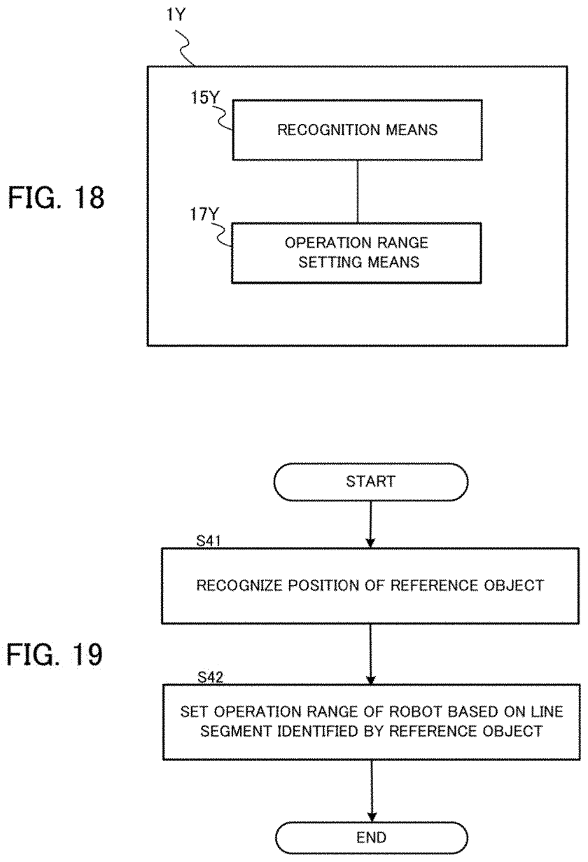

FIG. 18 is a schematic configuration diagram of an operation range setting device 1Y in the fourth example embodiment. As shown in FIG. 18, the operation range setting device 1Y includes a recognition means 15Y and an operation range setting means 17Y. The operation range setting device 1Y may be configured by a plurality of devices.

The recognition means 15Y is configured to recognize a position of a reference object. For example, the recognition means 15Y may be the recognition unit 15 in the second example embodiment.

The operation range setting means 17Y is configured to set an operation range of a robot based on a line segment identified by the reference object. For example, the operation range setting unit 17Y may be a combination of the safety plane generation unit 17 and the setting unit 18 in the second example embodiment.

FIG. 19 illustrates an example of a flowchart in which the operation range setting device 1Y executes in the fourth example embodiment. The recognition means 15Y is configured to recognize a position of a reference object (step S41). Then, the operation range setting means 17Y is configured to set an operation range of a robot based on a line segment identified by the reference object (step S42).

According to the fourth example embodiment, the operation range setting device 1Y can suitably set the operation range of the robots based on a reference object installed in accordance with a desired operation range.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments (including modifications, the same shall apply hereinafter) described above can be described as, but not limited to, the following Supplementary Notes.

[Supplementary Note 1]

An operation range setting device comprising:
a first recognition means configured to recognize positions of plural reference objects;
a second recognition means configured to recognize combinations of reference objects, the combinations each being selected to be a pair of the reference objects from the plural reference objects; and
an operation range setting means configured to set an operation range of a robot based on line segments, the line segments each connecting the pair of the reference object for each of the combinations.

[Supplementary Note 2]

The operation range setting device according to Supplementary Note 1,
wherein the operation range setting means is configured to set a safety plane that is a plane to regulate the operation range,
the safety plane overlapping with the line segment and being perpendicular to a reference plane that is used as a reference in a control of the robot.

[Supplementary Note 3]

The operation range setting device according to Supplementary Note 1,
wherein the operation range setting means is configured to set a safety plane that is a plane to regulate the operation range,
the safety plane overlapping with a second line segment and being perpendicular to a reference plane that is used as a reference in a control of the robot,
the second line segment being the line segment translated in each of directions perpendicular to the line segment on the reference plane.

[Supplementary Note 4]

The operation range setting device according to any one of Supplementary Notes 1 to 3,
wherein the first recognition means is configured to recognize the positions of the plural reference objects based on a detection result of a marker provided on each of the plural reference object.

[Supplementary Note 5]

The operation range setting device according to any one of Supplementary Notes 1 to 4,
wherein the second recognition means is configured to recognize the pair of the reference objects based on a presence or absence of a second object connecting the pair of the reference objects.

[Supplementary Note 6]

The operation range setting device according to any one of Supplementary Notes 1 to 4,
wherein the second recognition means is configured to recognize, as the pair of the reference objects, two reference objects with a redetermined positional relation with a second object.

[Supplementary Note 7]

The operation range setting device according to Supplementary Note 5 or 6, wherein the second recognition means is configured to detect the second object based on a color of the second object or a presence or absence of a marker of the second object.

[Supplementary Note 8]

The operation range setting device according to any one of Supplementary Notes 1 to 4,
wherein the second recognition means is configured to recognize the pair of the reference objects based on input information specifying the pair of the reference objects.

[Supplementary Note 9]

The operation range setting device according to any one of Supplementary Notes 1 to 8,
wherein the first recognition means is configured to recognize the positions of the plural reference objects based on information generated by a sensor whose detection range includes the plural reference objects.

[Supplementary Note 10]

The operation range setting device according to Supplementary Note 9,
wherein the sensor is provided in the robot, and
wherein the first recognition means is configured to cause the robot to move so that the detection range includes the plural reference objects.

[Supplementary Note 11]

The operation range setting device according to Supplementary Note 9 or 10,
wherein the sensor is a camera, a range sensor, or a combination thereof

[Supplementary Note 12]

The operation range setting device according to any one of Supplementary Notes 9 to 11, further comprising
a coordinate system conversion means configured to convert the positions of the plural reference objects in a coordinate system with respect to the sensor into the positions of the plural reference objects in a coordinate system with respect to the robot used in a control of the robot.

[Supplementary Note 13]

The operation range setting device according to 2 or 3,
wherein the reference objects are columnar objects extending perpendicularly to the reference plane.

[Supplementary Note 14]

The operation range setting device according to any one of Supplementary Notes 1 to 13,
wherein the reference objects are removed before an operation of the robot.

[Supplementary Note 15]

An operation range setting device comprising:
a recognition means configured to recognize a position of a reference object; and
an operation range setting means configured to set an operation range of a robot based on a line segment identified by the reference object.

[Supplementary Note 16]

The operation range setting device according to Supplementary Note 15,
wherein the reference object is a tape applied to a floor or a wall.

[Supplementary Note 17]

An operation range setting method executed by a computer, the control method comprising:
recognizing positions of plural reference objects;
recognizing combinations of reference objects, the combinations each being selected to be a pair of the reference objects from the plural reference objects; and
setting an operation range of a robot based on line segments, the line segments each connecting the pair of the reference object for each of the combinations.

[Supplementary Note 18]

A storage medium storing a program executed by a computer, the program causing the computer to:
recognize positions of plural reference objects;
recognize combinations of reference objects, the combinations each being selected to be a pair of the reference objects from the plural reference objects; and
set an operation range of a robot based on line segments, the line segments each connecting the pair of the reference object for each of the combinations.

[Supplementary Note 19]

An operation range setting method executed by a computer, the control method comprising:
recognizing a position of a reference object; and
setting an operation range of a robot based on a line segment identified by the reference object.

[Supplementary Note 20]

A storage medium storing a program executed by a computer, the program causing the computer to:
recognize a position of a reference object; and
set an operation range of a robot based on a line segment identified by the reference object.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1X, 1Y Operation range setting device
2 Input device
3 Display device
4 Camera (imaging means)
Robot control device
6 Robot
7, 7A to 7D Columnar object
8, 8A to 8D Rope
9, 9A to 9C Cone
14A to 14D Marker
25, 25A to 25C, 25X, 25Y Tape
100 Robot management system

What is claimed is:

1. An operation range setting device comprising:
at least one memory configured to store instructions; and
at least one processor configured to execute the instructions to:
recognize positions of plural reference objects;
recognize combinations of reference objects, the combinations each being selected to be a pair of the reference objects from the plural reference objects; and
set an operation range of a robot based on line segments, the line segments each connecting the pair of the reference object for each of the combinations.

2. The operation range setting device according to claim 1,
wherein the at least one processor is configured to execute the instructions to set a safety plane that is a plane to regulate the operation range,
the safety plane overlapping with the line segment and being perpendicular to a reference plane that is used as a reference in a control of the robot.

3. The operation range setting device according to claim 1,
wherein the at least one processor is configured to execute the instructions to set a safety plane that is a plane to regulate the operation range,
the safety plane overlapping with a second line segment and being perpendicular to a reference plane that is used as a reference in a control of the robot,
the second line segment being the line segment translated in each of directions perpendicular to the line segment on the reference plane.

4. The operation range setting device according to claim 1,
wherein the at least one processor is configured to execute the instructions to recognize the positions of the plural reference objects based on a detection result of a marker provided on each of the plural reference object.

5. The operation range setting device according to claim 1,
wherein the at least one processor is configured to execute the instructions to recognize the pair of the reference objects based on a presence or absence of a second object connecting the pair of the reference objects.

6. The operation range setting device according to claim 1,
wherein the at least one processor is configured to execute the instructions to recognize, as the pair of the reference objects, two reference objects with a redetermined positional relation with a second object.

7. The operation range setting device according to claim 5,
wherein the at least one processor is configured to execute the instructions to detect the second object based on a color of the second object or a presence or absence of a marker of the second object.

8. The operation range setting device according to claim 1,
wherein the at least one processor is configured to execute the instructions to recognize the pair of the reference objects based on input information specifying the pair of the reference objects.

9. The operation range setting device according to claim 1,
wherein the at least one processor is configured to execute the instructions to recognize the positions of the plural reference objects based on information generated by a sensor whose detection range includes the plural reference objects.

10. The operation range setting device according to claim 9,
wherein the sensor is provided in the robot, and
wherein the at least one processor is configured to execute the instructions to cause the robot to move so that the detection range includes the plural reference objects.

11. The operation range setting device according to claim 9,
wherein the sensor is a camera, a range sensor, or a combination thereof.

12. The operation range setting device according to claim 9,
wherein the at least one processor is configured to further execute the instructions to convert the positions of the plural reference objects in a coordinate system with respect to the sensor into the positions of the plural reference objects in a coordinate system with respect to the robot used in a control of the robot.

13. The operation range setting device according to claim 2,
wherein the reference objects are columnar objects extending perpendicularly to the reference plane.

14. The operation range setting device according to claim 1,
wherein the reference objects are removed before an operation of the robot.

15. An operation range setting device comprising:
at least one memory configured to store instructions; and
at least one processor configured to execute the instructions to:
recognize a position of a reference object; and
set an operation range of a robot based on a line segment identified by the reference object.

16. The operation range setting device according to claim 15,
wherein the reference object is a tape applied to a floor or a wall.

17. An operation range setting method executed by a computer, the control method comprising:
recognizing positions of plural reference objects;
recognizing combinations of reference objects, the combinations each being selected to be a pair of the reference objects from the plural reference objects; and
setting an operation range of a robot based on line segments, the line segments each connecting the pair of the reference object for each of the combinations.

18. (canceled)
